(19) United States
(12) Patent Application Publication
(10) Pub. No.: US 2004/0008648 A1
(43) Pub. Date: Jan. 15, 2004

(54) Diversity decisions for downlink antenna transmission

(76) Inventors: Timothy M. Schmidl, Dallas, TX (US); Anand G. Dabak, Plano, TX (US)

Correspondence Address: Ronald O. Neerings, Texas Instruments Incorporated, M/S 3999, P.O. Box 655474, Dallas, TX, 75265, US

(21) Appl. No.: 10/409,731

(22) Filed: Apr. 9, 2003

Related U.S. Application Data
(60) Provisional application No. 60/395,076, filed on Jul. 11, 2002.

(51) Int. Cl. H04B 7/216

(52) U.S. Cl. 370/335; 370/329

(57) ABSTRACT

A decision (27) with respect to the use of transmit diversity in an HSDPA transmission can be made based on a characteristic (21, 22, 23, 24, 25, 26) associated with the HSDPA transmission.

This application claims the priority under 35 U.S.C. § 119(e)(1) of copending U.S. provisional application No. 60/395,076 filed on Jul. 11, 2002, and incorporated herein by reference.

### FIELD OF THE INVENTION

The invention relates generally to transmit diversity in wireless communications and, more particularly, to selection of transmit diversity for downlink.

### BACKGROUND OF THE INVENTION

HSDPA (high speed downlink packet access) is the evolution of WCDMA that supports higher cell throughput through the use of hybrid ARQ, adaptive modulation and coding, and intelligent scheduling. Since the spreading factor is only 16, and many of the 16 Walsh codes of length 16 are used for HSDPA, multipath can significantly limit throughput. In an environment with significant multipath, equalizers or interference cancellers may need to be employed at the mobile receiver (UE or user equipment) in order to achieve good performance.

Transmit diversity is known to decrease bit error rates and increase cell capacity for voice calls. There is open loop transmit diversity (STTD or space-time transmit diversity) and closed loop transmit diversity (TxAA or transmit adaptive array). Both STTD and TxAA are supported in the Release 99 WCDMA standard.

When the features of HSDPA are combined with transmit diversity, sometimes transmit diversity can decrease the throughput for some users. A scheduler which chooses the desired user based on a maximum C/I criterion or using a proportional fair algorithm will take advantage of the upfades to each user and will schedule traffic to each user when the channel to that particular user is good. Antenna diversity tends to minimize the effects of fading, so the channel quality does not vary as much as when single antenna transmission is used. Because the C/I distribution with a single transmit antenna has heavier tails than the C/I distribution with transmit diversity, a scheduler which takes advantage of the heavy tail when the C/I is high can result in a higher throughput for a single transmit antenna system.

It is therefore desirable to provide for and improve utilization of transmit diversity in HSDPA transmissions.

Exemplary embodiments of the invention make a decision with respect to the use of transmit diversity for an HSDPA transmission based on information indicative of a communication characteristic associated with the HSDPA transmission.

### BRIEF DESCRIPTION OF THE DRAWINGS

FIG. 1 diagrammatically illustrates exemplary embodiments of a wireless communication transmitter apparatus according to the invention.

FIG. 2 diagrammatically illustrates exemplary operations which can be performed by the exemplary wireless communication transmitter apparatus of FIG. 1.

### DETAILED DESCRIPTION

Exemplary embodiments of the invention can be used at the base station or network to decide when to use transmit diversity for sending data to a particular UE. In this document the terms base station and Node B are used interchangeably. Similarly, the terms network and RNC are used interchangeably. There are several exemplary considerations that can be taken into account when deciding what type of transmit diversity to use.

At low Doppler rates where the channel changes fairly slowly, a closed loop transmit diversity technique is effective in improving performance. At higher Doppler rates when the channel changes quickly, the feedback information from the UE to the Node B becomes quickly outdated. By the time new antenna weights are available, the channel has already changed. In high Doppler environments, STTD gives better performance. The Doppler rate can be estimated for each UE by some standard Doppler estimation techniques such as computing the channel correlation versus time delay.

In HSDPA, multipath becomes a limiting factor in performance. In a heavy multipath channel, it is often better to transmit without using transmit diversity. Since the Node B will have at least two transmit antennas, when transmit diversity is not employed, the Node B simply transmits the same signal on each antenna in order to avoid power imbalance problems. Alternatively, the base station may choose to transmit the information to a UE on only one antenna when in the no transmit diversity mode. The effect of multipath is made worse when a large number of multicodes are used, since the multicodes will cause interference to each other.

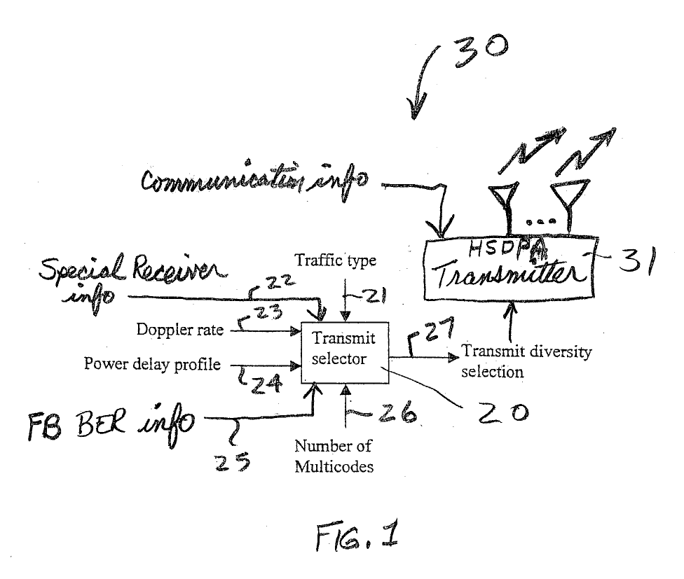

FIG. 1 shows exemplary embodiments of a wireless communication transmitter apparatus 30 including a transmit selector 20 according to the invention. The apparatus 30 operates at Node B or the RNC. Selector 20 can take as inputs one or more of the following: traffic type, Doppler rate, QoS, power delay profile, and number of multicodes to be used.

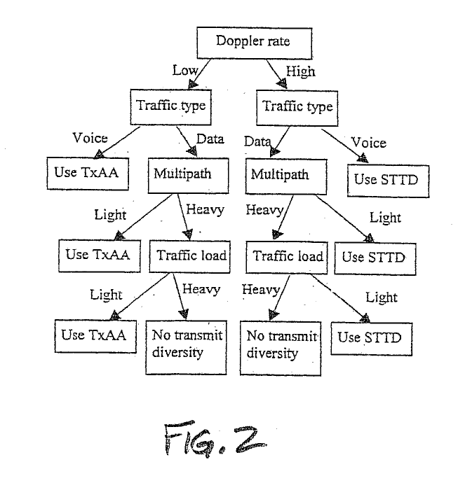

The transmit selector may use a variety of algorithms to determine at 27 what type of transmit diversity to use for a particular UE. FIG. 2 shows an example of a flow chart that can be used to determine what type of transmit diversity to use to transmit to a particular UE.

If the traffic type is voice, and the Doppler rate is low (e.g., below 120 Hz), then the transmit selector can decide to use TxAA. If the traffic type is voice and the Doppler rate is high (e.g., above 120 Hz), then the transmit selector can use STTD.

For packet data traffic, if the traffic load is light or there is not much multipath, then for low Doppler TxAA can be used and for high Doppler STTD can be used. If the traffic load is heavy and there is strong multipath, then no transmit diversity should be used, and instead the same signal will be transmitted from both transmit antennas.

The definition of a light traffic load could mean that 5 or fewer of the 16 multicodes are used for HSDPA. Light multipath could be defined, e.g, as all the other multipaths being 8 dB or more weaker than the strongest path.

The thresholds given above are just examples and can be modified as desired.

Different algorithms can be used in the transmit selector block. For example, the input values can be compared to stored values, and pattern matching can be used to determine which pattern is closest to the input to decide upon the transmit diversity technique.

The transmit selector can also take into account whether some form of advanced receiver technique such as equalization or interference cancellation is used at the UE, or whether the receiver uses multiple receive antennas, since such advanced receivers can tolerate more multipath.

Since TxAA does not work well when the feedback (FB) bit error rate on the uplink is high, the feedback bit error rate can be estimated and used as an input into the transmit selector. When the feedback bit error rate is high, TxAA would not be used for data packets. The feedback BER could be high when the UE is in soft handoff or at the edge of a cell, so these conditions could be used at 25 in place of explicitly estimating the feedback BER.

The transmit selector 20 can be provided in the UE so the UE can perform the transmit selection instead of the Node B or RNC.

The transmit selector can also be used in combination with beamforming. For example, the transmitter 31 can (in some embodiments) use a combination of TxAA and beamforming, so the transmit selector can determine whether TxAA should be included with the beamforming or whether a pure beamforming can be used for a particular UE.

Various embodiments use various ones and/or combinations of the input characteristics 21-26 shown feeding the transmit selector of FIG. 1.

It will be apparent to workers in the art that the above-described techniques are applicable to communications other than HSDPA communications, for example, 1XEV-DV communications.

Although exemplary embodiments of the invention are described above in detail, this does not limit the scope of the invention, which can be practiced in a variety of embodiments.

What is claimed is:

1. A method of controlling HSDPA transmission, comprising:
providing information indicative of a communication characteristic associated with a desired HSDPA transmission;
based on said information, making a decision with respect to use of transmit diversity in said HSDPA transmission; and
performing said HSDPA transmission based on said decision.

2. The method of claim 1, wherein said communication characteristic is whether said HSDPA transmission is a data transmission or a voice transmission.

3. The method of claim 2, wherein said communication characteristic is a Doppler rate.

4. The method of claim 3, wherein said communication characteristic is multipath interference.

5. The method of claim 4, wherein said communication characteristic is traffic load.

6. The method of claim 1, wherein said communication characteristic is a Doppler rate.

7. The method of claim 1, wherein said communication characteristic is multipath interference.

8. The method of claim 1, wherein said communication characteristic is traffic load.

9. The method of claim 1, wherein said communication characteristic is a characteristic of a receiver which will receive said HSDPA transmission.

10. The method of claim 1, wherein said communication characteristic is a bit error rate.

11. The method of claim 1, wherein said performing step includes using beamforming to perform said HSDPA transmission.

12. The method of claim 1, wherein said making step includes deciding between use of closed loop transmit diversity and open loop transmit diversity.

13. The method of claim 1, wherein said making step includes deciding whether to use transmit diversity.

14. The method of claim 13, wherein said making step includes deciding between use of closed loop transmit diversity and open loop transmit diversity.

15. The method of claim 14, wherein said performing step includes combining transmit diversity with beamforming based on said making step.

16. An apparatus for controlling HSDPA transmission, comprising:
an input for receiving information indicative of a communication characteristic associated with a desired HSDPA transmission; and
a transmit selector coupled to said input for receiving said information, said transmit selector responsive to said information for making a decision with respect to use of transmit diversity in said HSDPA transmission.

17. The apparatus of claim 16, wherein said information is indicative of one of a Doppler rate, multipath interference, traffic load, a bit error rate, a characteristic of a receiver that will receive said HSDPA transmission, and whether said HSDPA transmission is a data transmission or a voice transmission.

18. The apparatus of claim 16, wherein said information is indicative of whether said HSDPA transmission is a data transmission or a voice transmission, and wherein said information is further indicative of a Doppler rate, multipath interference, and traffic load.

19. The apparatus of claim 16, provided in a fixed site transmitter.

20. An HSDPA transmission apparatus, comprising:
an input for receiving information indicative of a communication characteristic associated with a desired HSDPA transmission;
a transmit selector coupled to said input for receiving said information, said transmit selector responsive to said information for making a decision with respect to use of transmit diversity in said HSDPA transmission; and
a transmitter coupled to said transmit selector for performing said HSDPA transmission based on said decision.

21. The apparatus of claim 20, wherein said information is indicative of one of a Doppler rate, multipath interference, traffic load, a bit error rate, a characteristic of a receiver that will receive said HSDPA transmission, and whether said HSDPA transmission is a data transmission or a voice transmission.

22. The apparatus of claim 20, wherein said information is indicative of whether said HSDPA transmission is a data transmission or a voice transmission, and wherein said information is further indicative of a Doppler rate, multipath interference, and traffic load.

23. A method of controlling 1XEV-DV transmission, comprising:
providing information indicative of a communication characteristic associated with a desired 1XEV-DV transmission;
based on said information, making a decision with respect to use of transmit diversity in said 1XEV-DV transmission; and
performing said 1XEV-DV transmission based on said decision.

24. An apparatus for controlling 1XEV-DV transmission, comprising:
an input for receiving information indicative of a communication characteristic associated with a desired 1XEV-DV transmission; and
a transmit selector coupled to said input for receiving said information, said transmit selector responsive to said information for making a decision with respect to use of transmit diversity in said 1XEV-DV transmission.
